(19) United States
(12) Patent Application Publication
(10) Pub. No.: US 2006/0018698 A1
(43) Pub. Date: Jan. 26, 2006

(54) System including apparatus and associated method for object decoration

(75) Inventor: Thomas J. Vogt, Cincinnati, OH (US)

Correspondence Address: WOOD, HERRON & EVANS, LLP, 2700 CAREW TOWER, 441 VINE STREET, CINCINNATI, OH, 45202, US

(73) Assignee: Multi-Color Corporation

(21) Appl. No.: 10/898,864

(22) Filed: Jul. 26, 2004

(51) Int. Cl. B41J 1/50

(52) U.S. Cl. 400/149

(57) ABSTRACT

The present invention provides a decorating system that applies images directly to the surface of an item. This decorating can occur with no contact between a printing engine and the item and/or with a single pass of the printing engine proximal to the item. The decoration of items can further include computer control of the printing system to allow for creating of a decoration image at a first location, and transfer of that image to a second location for application of that image directly to the surface of an item to be decorated.

### FIELD OF THE INVENTION

The present invention relates generally to a system, including an apparatus and associated method, for applying decoration to items, and particularly to an apparatus and associated method used to apply decorations including label-type information to containers and other items that require such decoration.

### BACKGROUND OF THE INVENTION

Decorations, such as labels, are commonly used in the decorating of commercial items, such as containers for beverages, oils, detergents, chemicals, and health and beauty aids. In the label industry, there are various types of labels, including, but not limited to, shrink sleeve labels, pressure-sensitive labels, in-mold labels, and heat transfer labels. In general, the production of these types of labels may be accomplished with a printing plate or cylinder. The plate or cylinder is pressed or rolled against a substrate (such as paper, polyethylene, polypropylene, etc.) in order to transfer any graphics from the plate or cylinder to the substrate. The substrate may include an adhesive such that the substrate itself is directly applied to a surface of an item. Alternatively, the graphics may be reverse-printed on the substrate to then be rolled against an item to transfer the inks (and any other substance, such as adhesive) from the substrate onto the item surface. This process of applying the label to an item, such as a container, can be very involved.

For example, application of pressure-sensitive labels to items to which they are affixed occurs in machinery in which the adhesive labels are associated with a carrier web which passes along and in contact with items which require decoration. As the web including labels passes along and in contact with the items, the label is released from the web and adheres to the items. More specifically, the equipment is generally designed so that the web having labels associated therewith passes across a transfer roll of a decorating station in proximity to an item conveyor. The item conveyor carries items to be labeled along a labeling path and positions an item in front of and in confronting relationship with the transfer roll. The item is then rotated against the label and web, which is drawn across the transfer roll. The web is drawn at a velocity so that the web speed and the surface velocity of the item are substantially equal. Because the web carries the adhesively active labels, the label is essentially released from the web and applied to the item as they move against one another. Once a label has been applied, the item conveyor moves the labeled item away from and out of confronting relationship with the transfer roll and moves the next unlabeled item into position in front of and in confronting relationship with the transfer roll, and stops the item in that position, where the labeling process is repeated.

The above is merely exemplary of the many components, complex machinery, and processes involved in the application of pressure-sensitive labels to items. Similar components, machinery, and complex processes are involved in the application of other standard types of labels, such as shrink sleeves, pressure-sensitive labels, and in-mold labels.

The application of the label to an item is only one part of the even lengthier and more complex and costly process of taking a label from conception and design to use as a decoration on a product in the market. This process is a lengthy one, and may involve a number of different entities. For example, any label must first be conceived and designed. Such a process may be handled either in-house by a marketing/design department or may be outsourced to a firm specializing in such design. Following conception of a label design, a design proof is created. Once a design proof has been created, revised appropriately, and approved, the proof must be submitted for production. The design of the proof is printed onto a substrate for approval.

The actual printing of the label involves several steps. First, as described briefly above, printing plates or cylinders must be created which include an image of the design from the proof. This may be a standard image or a “reverse” image, depending upon the type of label to be created. Inks must then be selected to match the colors of the proof and applied to the plates or cylinders. A substrate must then be produced and/or purchased in order to receive the inks from the plates or cylinders. The plates or cylinders then transfer any inks to the substrate by pressing, stamping, or rolling the ink images onto the substrate. The substrate is then cut into individual labels in an amount sufficient to satisfy the production run of the product to which it is to be applied. Further, any one of a number of substrates may be used in order to produce different types of labels, such as shrink sleeves, pressure sensitive labels, in-mold labels, and heat transfer labels.

Once the labels have been produced, they then must be shipped to each location that includes a production line of the items to be labeled. This results in cost for freight, as well as the cost of storage prior to shipping and the cost of storing any unused portion of the label supply. Further, any such production run necessarily includes an extra number of labels to replace any labels damaged during storing, shipping or application to containers. Once all containers are labeled, there is also the cost of waste. This waste may take the form of damaged labels or labels that are ultimately discarded following non-use, and/or in the case of pressure-sensitive and heat-transfer labels, there is the added waste of the carrier layer of the label that must be discarded following its removal. In many instances, labels can be damaged during production due to the fact that the plates or cylinders actually contact the substrate of the label. As a result, a smearing of the ink can occur, thereby ruining the label. Additionally, multiple plates and cylinders are used in conventional label printing processes. This is because only certain inks are transferred to the substrate from each of the plates or cylinders. As a result, inks are applied onto one another to create the images and the different colors on the label or other decoration. The use of multiple plates or cylinders, due to the different inks to be applied, can result in the improper registration of the inks one to another, thereby creating defective labels (through images that are not correctly superimposed, and/or through the improper mixing of inks which prevents the desired color from being created). The numerous process steps, types of process steps, and the number of components and entities involved contribute to a time-consuming and costly process that ultimately results in an increased price for the finished label and/or finished item.

In addition to the problems of time and cost discussed above, there are other drawbacks to current labeling processes. For example, certain drawbacks arise when labels are customized, such that the labels differ slightly even though used on the same product. Current methods require customized labels to be made separately, and multiple lines to be run in order to print and apply variations of a single label. This may be required for labels to signify special promotions (i.e., an extra graphic may be superimposed on the standard label), or for mixed case packaging (i.e., a case is produced wherein a certain number of labels include a first graphic and a certain number include a second graphic), or printing in different languages for products that will be distributed in different geographical regions, to name a few examples.

An additional problem created by the current types of labels and methods for producing and applying those labels is that it is impossible to guarantee exact reproduction at the production line of the design proof image that has been viewed and approved at a different location. This not only occurs between local entities, but the printing of a label also may vary between production lines in different nations (i.e. the images produced in China will not appear to be the same as those produced in the United States). This creates non-uniformity of labels across a product line and can lead to the loss of brand equity.

As can be seen, there are several inherent disadvantages in the current conventional systems for producing and applying labels and other decorations. In particular, costs are high due to the number of different components (i.e., design proofs, plates, cylinders, etc.) and other attendant costs (freight, storage, waste, etc.). Further, it is difficult to rapidly and efficiently customize decorations, such as labels, since to do so would require printing different designs and either operating multiple lines or taking the time to shut down a particular line to load in a different type of label. Additionally, the number of entities, components, shipping, steps in production, etc. as described above is all time-consuming, and thereby serves to reduce the speed-to-market of a product. And finally, as described above, the present systems for creating, producing, and applying labels does little to promote uniformity, and thus brand equity, among product lines at different locations.

It would therefore be desirable to provide a system of creating, producing, and applying decorations, such as labels, and/or including label-type information, which reduces the costs involved, allows for rapid and efficient customization of decorations, reduces the time involved in order to increase speed-to-market for a product line, and provides for uniformity of the decoration across an entire product line.

With these features in mind, as will be apparent to those skilled in the art, the present invention provides a system, including an apparatus and associated method, having these desired characteristics, as is described below in the specification and is covered by the claims attached thereto.

### SUMMARY OF THE INVENTION

The present invention overcomes the drawbacks described above in current decorating systems, such as those used for labeling, by replacing conventional apparatus and methods with a system that applies images directly to the surface of an item. The application of ink directly to the item to be decorated reduces many components, and thus costs, associated with conventional systems. For example, the substrate of the conventional label is eliminated, and thus so are the costs related to the use of a substrate. Further, the present invention allows for the elimination of standard printing components, such as plates and cylinders. Additionally, the present invention allows for transmission of a design proof directly to a production line, thereby eliminating the time and cost involved with freight, storage, and waste.

In particular, decoration by the system of the present invention may be accomplished via digital printing of the label from a printing engine onto the item. This results in several advantages not previously achieved in conventional labeling. For example, the label design can be digitally recorded, and thus when completed can be transmitted directly to the production line via various transmission methods, including internet and satellite. Also, the use of digital images via computer control allows for ease of mixed case labeled items in that the application of different decorations does not require different lines, nor does the process require an operator to switch out plates or cylinders (since plates and cylinders are eliminated, along with, the costs attendant to production, use, and maintenance of plates and cylinders). Rather, a single printing engine can simply be instructed to print a first item with a first decoration and a second item with a different second decoration. Further, eliminating the substrate reduces the cost, and thus the price, of placing an image and/or other label-type information on an item.

Decoration via digital printing directly onto an item allows for applications outside the labeling industry. For example, decorations may be applied to any number of household items (for example, printing colors or patterns from interior decor onto appliances, such that the appliances match the interior décor of a house). Since a digital image can be directly transferred to the printing engine via a computer, and then directly delivered to the items, the costs of doing so are not prohibitive.

Others in the industry have attempted to speed up throughput and reduce the cost of labeling. However, previously, the elimination of components such as the substrate has not been considered. Often, the cost of the substrate can approach 40%-75% of the finished label. In order to accomplish the elimination of the substrate and achieve digital decoration directly onto items to be labeled, a digital printing apparatus including an inkjet printing engine may be used. The particular printing engine used may be a single pass ink jet color engine. The inks used in the system of the present invention are compatible with this single pass ink jet color engine.

In addition to the reduction of costs involved, the system including printing of images directly onto a surface of items provides the following further advantages: (1) increase in speed-to-market of product by reducing decoration time; (2) increase in color control and ease of registration of multiple inks in order to achieve reproduction of images that are substantially identical to one another and to a design proof, thereby increasing brand equity; and (3) ease of customization.

To achieve these advantages, in certain embodiments the present invention provides a decorating apparatus including a printing engine having a plurality of print heads. Each of these print heads may be operatively connected to an ink supply including a quantity of ink. The plurality of print heads is adapted to create images by delivering the plurality of inks onto an item from the plurality of print heads. This item may be a container having an interior compartment. The images may be created on a surface of the item during a single pass of the printing engine proximal to the item to deliver ink thereto. Among other advantages, this increases the ease of registration of inks one to another. Further, the plurality of print heads and/or the item may be positioned relative to one another to decorate the item in the absence of any physical contact between the item and the plurality of print heads. Among other advantages, this also increases the ease of registration of the inks, and eliminates any “smearing.”

The present invention also provides a method of decorating an item. This method includes first providing an item to be decorated, the item including at least one surface to be decorated. The item may be an article having an interior compartment. An ink source is also provided, the ink source including at least one ink. The ink source is operatively connected to a printing engine including a plurality of print heads. The item and/or the ink source are then positioned relative to one another such that ink may be delivered onto the surface of the item in the absence of any physical contact between the item and the ink source. Further ink may be delivered onto the surface of the item during a single pass of the printing engine proximal to the item in order to create images on its surface.

In yet another embodiment, the present invention provides a method of presenting an item to be decorated to a decorating apparatus. The method includes providing an item to be decorated and a decorating apparatus. The decorating apparatus, as above, may include a printing engine having a plurality of print heads. Each of the print heads is operatively connected to an ink supply including a quantity of ink. The plurality of print heads is adapted to create images by delivering a plurality of inks onto an item. The item may have an interior compartment. The images are created on a surface of the item during a single pass of the printing engine proximal to the item to deliver ink thereto. Further, the plurality of print heads and/or the item are positioned relative to one another to decorate the item in the absence of any physical contact between the item and the plurality of print heads. The positioning of the item in proximity to the plurality of print heads is done in such a manner that the plurality of print heads confronts the item but does not physically contact the item. The images are then created on the item by delivering ink from the plurality of print heads to the item. The print heads are also kept a substantially constant distance from the item being decorated as the surface of the item is moved past the print heads or vice-versa. By doing so, the present invention also provides for a decoration for an item. This decoration includes at least one ink layer delivered onto a surface of an item in a configuration to create images on that surface.

In another embodiment, the present invention provides for computer control of the printing system. With this computer control, the present invention provides a system for decoration which reduces and/or eliminates all of the drawbacks discussed above in the Background of the Invention section. For example, the system may include at least a first computer at a design location adapted to be in communication with a second computer at a production line. The second computer is attached to a printing engine on the production line. A decoration, such as a label including images, words, logos, etc., may be created at the first design computer and approved for production. The file containing the image of the decoration may then be immediately transferred to the second computer, which may direct the printing engine to apply that approved decoration to containers. This eliminates many of the components of the prior conventional label systems, thereby reducing costs, along with reducing costs for freight, storage, and waste. Further, this eliminates the many different entities that may be involved in the creation of a design production of labels and application of labels to containers, by having a system that simply includes a design station with immediate transmission of decorations to a station which begins production of containers with the desired decoration. By reduction and/or elimination of the various steps, components, and entities involved, the present system also tremendously increases the speed-to-market of a product, and also increases the ease of customization. For example, a run on a production line may be changed simply by instructing the printing engine to print a certain number of containers with a first image and a certain number of containers with a second image. Further, due to the exact reproduction due to the digital images involved, the identical image can be applied at any production line anywhere in the world, thereby increasing brand equity.

The present invention also uses print characterization files to ensure decorated items in each location appear substantially identical regardless of where they are produced or on what material they are produced. In particular, the print characterization information includes a print curve, which is an analysis that results in a profile of the print engine that correlates the color information of what was intended to be printed by a particular printing engine to what was actually produced. The print curve thus represents the difference between how the print engine is intended to print and how it actually prints. Thus, the print curves are used in a print characterization file by a print engine to modify a master print image so that a resulting decoration appears as intended.

In particular, the present invention may provide a method for decorating an item with an image. In accordance with this method, notification is received at one computer related to availability of an image file. In response, the image file is retrieved from a memory storing the image file and, in addition, print characterization information is retrieved as well that represents information to ensure a uniform appearance of a decorated item regardless of its production parameters. Then, a printing engine, coupled to the computer, is controlled by the computer, based on the image file and the print characterization information, so as to print the image on the item. The memory may be located remotely from the computer so that the computer downloads the image file using a file transfer protocol such as FTP.

Additionally, the printing system of the present invention may provide a system for decorating an item with an image. This system includes one computer configured to receive notification from another computer regarding the availability of an image file. The computer receiving the notification is further configured to retrieve the image file and corresponding print characterization information from a memory where it is stored. In addition, the system includes a printing engine coupled with the computer and controlled by it so as to print the image on the item according to the image file and print characterization information. The image file is advantageously formatted to include a single copy of the image to be printed on the item.

Further, this aspect of the present invention may include a method for distributing an image with which to decorate an item. In accordance with this method, a printable image file and print characterization information are generated at a first computer; and a notification of the availability of the printable image file is sent to a remotely located second computer. In addition, the printable image file and print characterization information are forwarded to a memory that is accessible by the second computer. The second computer can then retrieve the printable image file from the memory and control a printing engine to decorate the item.

Another aspect of the present invention relates to a system for producing an item decorated with an image. In accordance with this aspect, the system includes a first computer coupled with a printing engine and a second computer located remotely from the first computer and coupled with another inkjet printing engine that is similar to the first inkjet printing engine. The first computer is configured to notify the second computer of the availability of an image file and to forward the image file to a memory accessible by the second computer. In response, the second computer is configured to retrieve the image file from the memory and to decorate an item, using its printing engine, according to the image file. In this way, the first computer and printing engine can provide a proof of the decorated item while the second computer and printing engine can produce the decorated item en masse.

This aspect of the present invention also includes a method for producing an item decorated with an image. In accordance with this method an image file is generated at a first computer and a notification about the availability of the image file is sent from the first computer to a second computer. The first computer also forwards the image file along with print characterization information to a memory accessible by the second computer, wherein the second computer located remotely from the first computer. The second computer can then download the image file and print characterization information from the memory and ultimately decorate the item, according to the image file and characterization information, using a printing engine. This method may also include the additional steps of decorating a first item with an image file using a first inkjet printing engine coupled to a first computer and then waiting to receive approval from a producer regarding the first item as decorated before sending the image file to the memory. This method, as well as those described previously, may be implemented as a software program that executes on one or more processors and embodied on a computer-readable medium.

These and other advantages of the application will be apparent to those of skill in the art with reference to the drawings and the detailed description below.

### BRIEF DESCRIPTION OF THE DRAWINGS

While the invention has been disclosed by reference to the details of embodiments of the invention, it is to be understood that the disclosure is intended in an illustrative rather than in a limiting sense, as it is contemplated that modifications will readily occur to those skilled in the art, within the spirit of the invention and the scope of the appended claims.

FIG. 1 is a schematic representation of a decorating apparatus in accordance with the principles of the present invention;

FIG. 2 is a schematic representation of the decorating apparatus of FIG. 1 including a component for maintaining a substantially constant distance between print heads and an item being decorated, in accordance with the principles of the present invention;

FIG. 3 is a schematic diagram of a computer environment in which embodiments of the present invention may be implemented.

FIG. 4 is a functional-block diagram of a computer platform on which one or more embodiments of the present invention may be implemented.

### DETAILED DESCRIPTION OF THE INVENTION

As described above in the Summary of the Invention, the present invention overcomes the drawbacks described above in the Background of the Invention in conventional systems for decorating items, such as with labels, by replacing the conventional labels and labeling apparatus with a system that provides for the creation of a design proof on a computer and the subsequent transfer of that image as a digital image to a production line at any geographical region, for the immediate application thereof onto an item, such as a container, by a printing engine to deliver ink directly onto the surface of the item to create the image thereon.

In particular, in certain embodiments, the present invention provides a decorating apparatus including a printing engine having a plurality of print heads. Each of these print heads may be operatively connected to an ink supply including a quantity of ink. The plurality of print heads is adapted to create images by delivering the plurality of inks onto an item from the plurality of print heads. This item may be a container having an interior compartment. Alternatively, the item may be a planar-shaped item having an interior area (such as a flattened tube) that can later be shaped into a container having an interior compartment (such as a tube of toothpaste). The images may be created on a surface of the item during a single pass of the printing engine proximal to the item to deliver ink thereto. Further, the plurality of print heads and/or the item may be positioned relative to one another to decorate the item in the absence of any physical contact between the item and the plurality of print heads.

The printing engine described above may be a component of an ink-jet printer. In particular, one such ink jet printer that may be used is “the.factory” available from Agfa-Gevaert of Belgium. However, it will be apparent to those of skill in the art that the printing engine may be a component of any suitable device that serves the principles of the present invention. For example, such other devices may include, but are not limited to, bubble jet printers.

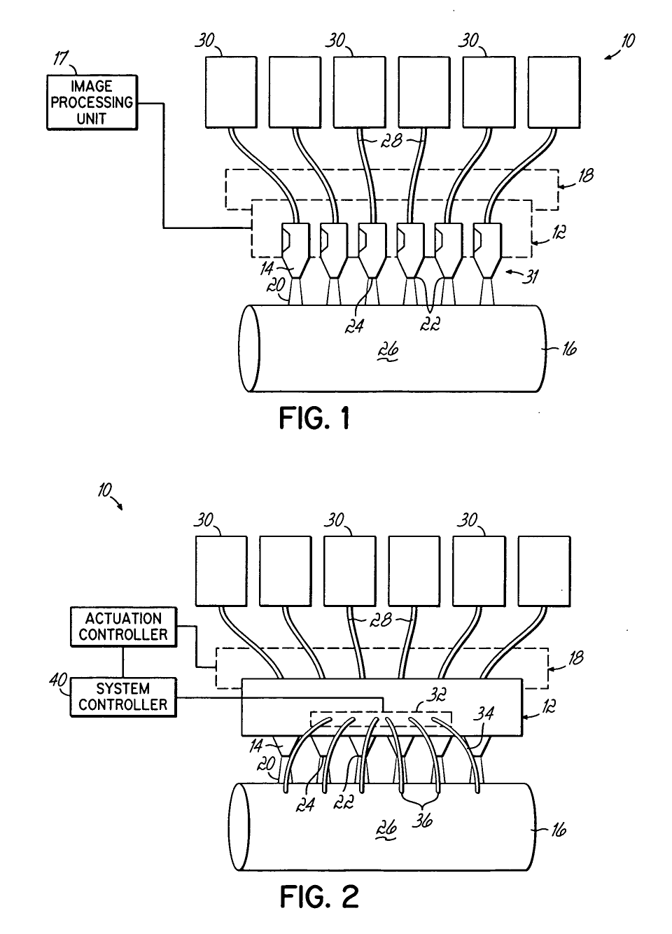

Referring to FIGS. 1 and 2, a general description of the printing engine of the decorating apparatus 10 of the present invention is as follows. The printing engine 12 includes a plurality of print heads 14 that may be vertically mounted jet-type ink jet print heads for printing an item 16 held in proximity to the print head 14. Since the print heads 14 are vertically mounted, the flight trajectory of the ink particles do not exhibit the drop curve associated with horizontally mounted print heads. However, it will be recognized by those of skill in the art that horizontally mounted print heads may be used in the apparatus of the present invention.

In particular, the item 16 may be held directly beneath the print head 14 and be adapted to be rotated or otherwise moved relative to the print head 14. The printing heads 14 perform printing on designated portions of the item 16, responsive to signals, such as digital signals, outputted by an imaging processing unit 17. This printing may be full color printing onto the item 16. The printing heads 14, and thus the printing engine 12, are mounted on an actuating unit 18 adapted for moving the printing heads 14. The printing heads 14 may be moved in a left-to-right horizontal direction with respect to the item being decorated, in a direction perpendicular to the horizontal direction, and/or may be moved vertically. Ink 20 is ejected from the distal ends 22 of the printing heads 14 in order to deliver ink 20 to designated portions of the item 16. The distance between the ejection point 24 of the printing heads 14 and the surface 26 of the item 16 to be decorated, may be selected to be in a range of approximately 0.5 mm to 8 mm.

Each of the printing heads 14 are connected by ink conduits 28 to an ink supply 30, such as ink tanks, respectively containing inks of various colors, as will be described below. The ink supply 30 may be an external unit, which allows the operator to easily refill ink while printing. The ink conduits 28 that lead from the respective ink tanks 30 are connected to the printing heads 14. Each color of ink may be directed to a number of print heads. And, each of the print heads receiving the same color of ink may be grouped together at a printing station 31. The apparatus 10 may include a plurality of printing stations (one for each ink color), each station including a plurality of print heads 14. The ink supply 30 is also connected to the image processing unit 17, either directly or indirectly through the printing engine 12, and is driven in response to digital signals and/or decoration data supplied from the memory of the image processing unit 17 for supplying inks 20 to the respective print heads 14.

As described above, the printing engine of the apparatus of the present invention may be a single pass ink jet color engine. “Single pass,” as used herein, means the printing stations cover the entire width of the surface of the item so the item passes the printing stations only once as the inks are delivered. In one embodiment, the single pass ink jet color engine includes four item-wide printing stations, one for each color. In another embodiment, the single pass ink jet color engine includes more than four item-wide printing stations (for example, six printing stations). The printing stations are equipped with an array of print heads covering a seamless item-wide print surface. The maximum printing width in one embodiment is approximately 630 mm, but can, for cost-effectiveness, be reduced by installing fewer print heads in the printing stations.

The print heads may be associated with related electronics, and a temperature control system for continuous print accuracy. The print heads, as will be described in greater detail below, may use piezo technology. When necessary, the print heads can be replaced by the system operator due to a “plug and play” positioning system.

In obtaining image quality with the single passing jet color engine, the print cartridges include a gray scale jetting capability. Per print head, eight levels of gray can be generated by varying the jetted drop size.

Further, the ink jet head nozzle plates may be automatically cleaned by a preventative maintenance unit. Automatic maintenance keeps the ink jet heads in good jetting condition and contributes significantly to the overall printing reliability of the whole system.

As described above, the printing engine includes a plurality of print heads that deliver ink from each of the print heads to the surface of the item to be decorated. In particular, each of the plurality of print heads may deliver ink of a color that differs from the color of ink delivered by each of the other of the plurality of print heads. Alternatively, more than one of the print heads may deliver the same ink. In one embodiment, the print engine may use four different inks: cyan, magenta, yellow, and black (CMYK), as is well known by those of skill in the art. However, in the illustrated embodiment, the decorating apparatus includes at least six inks for decoration in one pass of the printing engine proximal to the item to be decorated. These inks could include CMYK and up to two additional inks to increase the available colors used to decorate. Printing with six inks may be referred to herein as “hexachrome.” There are additional advantages that arise from the use of six inks instead of the standard four inks. Four basic colors can be used to create many different colors, but not all of the Pantone® colors. However, through the use of hexachrome, a much higher percentage of the Pantone® colors may be produced over the number that can be produced with the standard four CMYK inks. Such use of six inks is described in U.S. Pat. No. 6,550,905, the disclosure of which is incorporated by reference herein in its entirety.

With present printing systems, the use of hexachrome has not been embraced because the colors do not always register properly, and thus one cannot achieve a uniform color on the decoration. As described above, the inability to register inks, and therefore colors, results primarily from the use of plates and. cylinders in the printing process. For example, due to the mechanical control of the system, the label substrates do not always line up identically relative to a second cylinder as they do to a first cylinder. This may be caused by a slight stretching of the substrate as it progresses from the first cylinder to the second cylinder. Indeed, cylinders are often made of slightly different sizes in order to accommodate this stretching effect, but this is not always successful. Due to the use of computer control in the present decorating system (as opposed to the mechanical control of prior systems), colors can be registered accurately, and thus hexachrome may be used more accurately and therefore more efficiently than in prior art systems. Any stretching effect is also eliminated by the use of a single-pass printing engine (including all print heads in a single engine). Thus any stretching that might occur is imperceptible since the print heads deliver ink in rapid succession without the opportunity for the item to be stretched or registered incorrectly between passes (since there is only one pass).

The particular inks used in the present invention may be any ink suitable for use with printing engines such as inkjet printing engines. In particular, the inks used may be UV-curable inks. For example, suitable inks are described in U.S. Pat. No. 6,550,905, which is incorporated by reference herein in its entirety. As described in that reference, such an ink composition includes monomers (acrylates) possessing different degrees of functionality (average number of reactive groups per molecule), which can be combinations of mono, di, tri, and higher functionality materials. The components are selected to be UV curable via acrylic polymerization and to have the property of adhering to the surface of the item after decoration has occurred. Also included is a pigment. The acrylate components serve to bind the pigment. The ink may also include a photoinitiator. Due to the properties of this UV ink, it is not necessary to apply a varnish or overprint lacquer to improve scuff resistance on the product. As will be recognized by those of skill in the art, UV-curable inks are not the only inks that may be used in the system of the present invention. Any ink suitable for use in the types of decoration described may be used. Such inks and ink systems may include, but are not limited to, water based inks, solvent based inks, and electronic beam (EB) curable inks.

As described above, in the process of the present invention, ink is delivered onto a surface of an item to be decorated via each print head of the printing engine of the decorating apparatus. In particular the ink may be delivered from each print head by ejecting, spraying, dropping, or jetting the ink onto the surface of the item. The actual ejecting, spraying, dropping or jetting of the ink may further occur as described below.

In one embodiment, the ink is delivered to the surface of the item via a drop-on-demand delivery method. The drop-on-demand method includes at least two varieties: (1) thermal drop-on-demand, and (2) piezo drop-on-demand. In a particular embodiment of the present invention, the decorating apparatus employs a piezo-electric crystal to induce delivery of ink from the print heads to the surface of the item being decorated. In particular, the shape of the piezo-electric crystal may be altered in order to induce delivery of ink from a print head to the item surface. However, it will be recognized by those skilled in the relevant art that other drop-on-demand methods may be used to deliver ink. And further, it will be recognized by those of skill in the relevant art that drop-on-demand methods are not the only delivery methods that may be used. Any method of delivering ink from a print head to the surface of an item that is compatible with the system of the present invention may be used. For example, the ink may be delivered continuously to the surface of the item. In such an embodiment, each print head continuously ejects drops of ink. These drops of ink are charged. Each drop of ink is then either allowed to fall to the surface of the article, or a charge is used to affect the charge of the droplet to divert the droplet into a basket where it then may be recycled back to the ink supply.

As described previously, the item to be decorated includes at least one surface to be decorated and ink is delivered directly onto that surface. However, in alternate embodiments, ink may be delivered indirectly onto the surface. For example, the decorating system of the present invention may be used for offset printing. In such a situation, the print heads may be used to deliver inks and create “reverse” images on a “blanket.” This “blanket” serves as an item being decorated. Once the “blanket” has been imprinted with the images, the blanket can be molded to the contours of a container or other item in order to transfer the image from the “blanket” to the container. The inks may then subsequently be cured.

As described above, the printing engine of the apparatus of the present invention provides for delivering ink to the surface of items during a single pass of the printing engine proximal to the surface of the item. In one particular embodiment, a drive mechanism may move the item relative to the ink jet heads, or move the ink jet heads relative to the item, at a speed adjustable between 5 and 21 meters per minute. Six sets of print heads provide for printing between one and a plurality of colors in a single pass. Each print head prints a width of 70 mm, and between 2 and 9 print heads of each color can cover a width of up to approximately 630 mm on the item. The printing engine is capable of printing more than 900 m² per hour in a width of approximately 630 mm. In one embodiment, the printing engine prints up to 907 m² per hour. In one embodiment, each print head performs drop-on-demand half tone printing at 360 pixels per inch, with 3 bits, i.e., 8 gray-levels per pixel, giving a perceived quality of 3 times 360-1080 dots per inch. The print heads are capable of 5000 droplets per second. In alternate embodiments, the drive mechanism, printing engine, and print heads may exhibit different characteristics than those described above.

When the inks used in the present invention are UV curable inks, the printing engine may include at least a first UV source (a lamp) for curing the ink. The curing wavelength range of the first UV source is tunable. The power level is also adjustable up to about 200 watts per cm². In one embodiment, the first UV source includes a tubular mercury-doped discharge lamp and is designed to provide radiation particularly high in UVC, in particular, UVC in the wavelength range of 200-240 nm, to facilitate curing by direct ionization with little or no photoinitiator.

The images that are delivered to the item surface can be many and varied. For example, the images may include interpretable information, such as words, logos, pictures, or any other image which conveys information to one observing the image. Alternatively, the images may simply include random graphics, which have no particular message conveyed by their image. Such “random graphics” are often used in test runs of labels or other decorations.

As will be described in greater detail below, the decorating apparatus of the present invention may be used in a system having computer control to transmit an image from its point of creation on a computer, to a remote location including a printing engine, in order to eliminate substrates, shipping, storage, waste, etc. In such a system, the images created on computer and transferred to a remote computer and printing engine are digital images.

Further, the presently described decorating apparatus and decorating system provide for efficient and rapid customization of images being applied to items being decorated. In such an embodiment, the item being decorated is one of a plurality of items, that plurality of items including at least a first item and a second item. The decorating apparatus then can be instructed to apply a first image to the first item, and a different second image to a second item. For example, a container including detergents may include the same wording and logo on each of the first and second items, however the background pictures may be different on each (i.e., pictures of mountains on the first item with a tag reading “Mountain Fresh” and picture of fields with blue sky on the second item, with a tag reading “Cool Breeze”). By making it possible for each item passing through the decorating apparatus to be individually customized, it becomes possible to provide a “mixed case” of products directly at the production line, rather than having to produce a number of each type of item and then manually separate and combine the first and second items.

The present invention also provides a method of decorating an item. This method includes first providing an item to be decorated, the item including at least one surface to be decorated. The item may be an article having an interior compartment. An ink source is also provided, the ink source including at least one ink. The ink source is operatively connected to a printing engine including a plurality of print heads. The item and/or the ink source are then positioned relative to one another such that ink may be delivered onto the surface of the item in the absence of any physical contact between the item and the ink source. Further ink may be delivered onto the surface of the item during a single pass of the printing engine proximal to the item in order to create images on its surface.

In the method described above, the decorating apparatus, inks, etc. used may be the same as those described above with respect to the decorating apparatus itself.

In the decorating method of the present invention, images may be transferred from a first location to a single decorating apparatus. This first location may be the location where the image was originally created, where the image was finally edited, where the image was approved for production, etc. The decorating apparatus to which it is transferred may be local or may be geographically distant from the point of creation of the image. Alternatively, images may be transferred from the first location to a plurality of decorating apparatus. This transfer may occur simultaneously to each of the plurality of decorating apparatus.

When the method of the present invention involves a plurality of decorating apparatus, that plurality may include a first decorating apparatus and a second decorating apparatus. The first apparatus may be geographically distant from the second apparatus. In one particular embodiment, the images transferred to a surface of an item at each of the plurality of decorating apparatus may be identical to one another.

As described above with respect to the decorating apparatus itself, the item may be one of a plurality of items, the plurality of items including a first item and a second item, and the images including a first image and a second image. The first image may be created on the first item and the second image may be created on the second item. The first item and the second item may be decorated at a first location. Alternatively, the first item is decorated at a first location and the second item is decorated at a second location.

In yet another embodiment, the present invention provides a method of presenting an item to be decorated to a decorating apparatus. The method includes providing an item to be decorated and a decorating apparatus. The decorating apparatus, as above, may include a printing engine having a plurality of print heads. Each of the print heads is operatively connected to an ink supply including a quantity of ink. The plurality of print heads is adapted to create images by delivering a plurality of inks onto an item. The item may have an interior compartment. The images are created on a surface of the item during a single pass of the printing engine proximal to the item to deliver ink thereto. Further, the plurality of print heads and/or the item are positioned relative to one another to decorate the item in the absence of any physical contact between the item and the plurality of print heads. The method further includes positioning the item in proximity to the plurality of print heads, such that the plurality of print heads confronts the item but does not physically contact the item; and creating images on the item by delivering ink from the plurality of print heads to the item.

Creating images on the item further comprises moving the at least one print head and/or the item relative to one another while delivering ink to the item. In one embodiment, the item remains stationary and the at least one print head moves relative to the item. Alternatively, the at least one print head remains stationary and the item moves relative to the at least one print head.

The item includes a surface to be labeled and creating images on the item further comprises delivering ink to that surface. Such a surface may include a contour. In such a case, the item remains stationary and the at least one print head moves relative to the item and in conjunction with the contour such that as the at least one print head moves the at least one print head remains a substantially constant distance from the surface of the item. Alternatively, the at least one print head remains stationary and the item moves relative to the at least one print head and in conjunction with the contour such that as the item moves the item remains a substantially constant distance from the at least one print head.

The apparatus and method that allow for the print heads and or item to be moved relative to one another while keeping a substantially constant distance between the item and print heads, allow for the printing of article surfaces that are not substantially flat (such as conventional label substrates), but which may include curves, bends, or other contours or surface irregularities, such as many containers having interior compartments. Consequently, color fluctuations, and/or blurred lettering are avoided.

In particular, and referring to FIG. 2, detection apparatus 32 are provided on the printing engine 12, or other portion of the decorating apparatus 10 to detect curves or other irregularities on the item 16 being decorated. This allows for control of the height of the printing heads 14 relative to the item 16 being decorated. In one embodiment, the detection unit 32 is provided in the printing engine 12 and may include contour sensors 34, having contactors adapted for contacting the surface of the item 16. These contour sensors 34 are secured to the printing engine 12 at spaced locations with respect to the traveling direction of the item 16 being decorated, with the distal ends 36 of the contour sensors 34 projected from the printing engine 12.

The contour sensors 34 are adapted to deflect in any direction in an angular range of 360 degrees, and are adapted to contact the surface of the item 16 and to thereafter provide detection signals that indicate recesses, crests, curves, bends, and other surface irregularities of the item being decorated, to a system controller 40. The print engine actuating unit is then actuated under instructions from the system controller 40 on the basis of the detection signals from the contour sensors 34 for controlling the position of the height of the print heads 14 relative to the item 16 being decorated. In this manner, the distance of the printing heads 14 from the item 16 being contacted may be maintained as substantially constant at all times during decoration of the item 16. This enables continuous high quality decoration, regardless of surface irregularities in a manner free from color fluctuations or blurred letters. It will be recognized by those of skill in the art that contour sensors 34, including contour sensors 34 that actually physically contact the surface of the item, are not necessary to the present invention, and other types of contour sensors that may involve noncontact methods, may be employed in accordance with the principles of the present invention. For example, any type of laser displacement, ultrasonic, or photo-electric-type of contour sensors may be employed as contactors in the apparatus of the present invention.

In another embodiment, the present invention provides a decoration for an item. This decoration includes at least one ink layer delivered onto a surface of an item having an interior compartment in a configuration to create images on that surface. In particular, the ink layer is applied to the item via a single pass of a printing engine proximal to the item to deliver the ink layer thereto. The delivery of the ink may also occur in the absence of any physical contact between the item and the printing engine. As described above, the decorating apparatus, inks, etc. used to create the decoration of the present invention, as well as the images created, may be the same as those described above with respect to the decorating apparatus itself.

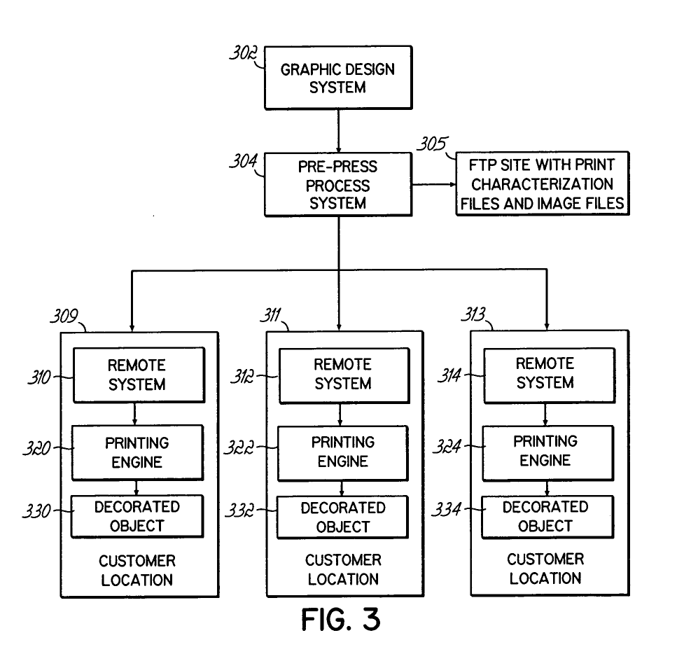

Turning now to a more detailed description of the system under computer control, FIG. 3 illustrates an exemplary functional diagram of the various computers and connections that may be used in accordance with certain embodiments of the present invention.

In particular, and as mentioned previously, an initial design for decorating an item is initially created by designers and other marketing personnel. This design process is typically performed on a computer system 302 using conventional graphic design software as known to one of ordinary skill. Alternatively, the design for the decoration may initially be performed manually and then converted to a digital representation by appropriate hardware and software of the computer system 302.

The initial design may include features and other characteristics that will make it difficult to reproduce accurately on certain containers or substrates. One skilled in the art of pre-press processing has the experience and knowledge to identify adjacent colors, adjacent shapes, design features, etc. that will likely be difficult to reproduce accurately during the printing process. Thus, the initial design is transferred to another computer system 304 where pre-press processing can be performed. Alternatively, the same computer 302, used for design, may be used for pre-press processing if it includes the appropriate software applications.

Assuming two separate computer systems 302, 304 are used, the design system 302 forwards or makes available the initial design file to the pre-press process system 304. The two systems 302, 304 may share disk storage space or may be connected via a network or other communications means. In either instance, the pre-press process system 304 receives or retrieves the initial design file and imports it into pre-press process software as is available and known to one skilled in this art. A pre-press engineer is then able to manipulate the initial design file into a format that is ready for printing. In an advantageous embodiment of the present invention, this master image file consists essentially of a single copy of the design image that will decorate an item. This is in contrast to previous printing file formats that included multiple renditions of the design image in a single file as was required by printing engines that included a stepper or similar means to transfer images to labels.

The master image file that is ready for printing is thus created using the pre-press process system 304. If an inkjet printing engine, (not shown), similar to that used at a production site, is locally connected to the system 304, then the master image file could be printed on a container, or item, that is a duplicate of the intended container at a remote production site. Accordingly, the container decorated locally to the system 304 would immediately illustrate how the design will appear on production items. Unlike previous proofing systems that merely render the design to approximate what the production item will look like, this system is able to produce an exact production item before the production run. If the design's appearance on the sample production item is not satisfactory to the pre-press engineer or to the customer, then the design may be changed at the design system 302 and/or the pre-press system 304 before any production items are produced at remote sites.

Even if a printing engine is not provided local to the pre-press process system 304, the computer generated image at this point still provides a closer approximation to what the ultimate decoration will look like compared to previous methods. As mentioned previously, the appearance of traditional proof copies can significantly differ from how the decoration will appear when reproduced on a label substrate. By using direct printing methods that avoid the use of a label during production runs, the master image file prepared for printing at system 304 better depicts the appearance of the ultimate production product. Additionally, this prepared image file may be easily shared via a network to a customer's location for viewing and approval before the production run begins. As is known to one of ordinary skill in the art, there are methods (e.g., gray scale correlation) to ensure that the color settings of two different video displays are calibrated such that color renditions on both are substantially the same.

One benefit of the present invention is that different locations can be used to produce decorated items in a controlled manner such that the decorated items appear substantially identical regardless of where they are produced or on what material they are produced. To achieve this benefit, embodiments of the present invention utilize print characterization files to ensure decorated items in all locations look the same.

As known to one of ordinary skill in this field, different colors are achieved on decorated items by mixing different inks with respective different densities. The density of a particular ink is usually referred to be within some range of 0% dot to 100% dot. The master image file includes information used by the print engine to control the ink colors and their respective densities to decorate the different areas of the item as intended. However, in operation, the resulting colors of the decorated item may not exactly match the intended color specified by the master image file. This variation may be due to the background color of the decorated item or manufacturing/operational variations of the print engine that exist within any mechanical device.

Accordingly, print characterization information is used to ensure uniformity among all decorated items bearing the same design regardless of their material and place of production. In particular, the print characterization information includes a print curve as is known to one of ordinary skill in this art. To produce a print curve, samples of different densities of inks are printed using a print engine and then analyzed by a calibrated color measuring device. This analysis results in a profile of the print engine that correlates the color information of what was intended to be printed to what was actually produced. For example, for a particular color, the ink density was intended to be 30% but the actually production item may exhibit a color density of 40%. Using, these variations for a variety of different densities, a print curve can be generated that represents the difference between how the print engine is intended to print and how it actually prints.

As another example, the color of a decorated item is affected by the background color on which the decoration appears. For example, the perceived colors of a decoration that appears on a blue item will appear different than the same decoration on a clear background and both will appear different than the same decoration on a white background. Different color print curves may be created for each different background color to represent how the background color changes the perceived color of the decoration on a particular item.

In use, the print curves are used in a print characterization file by a print engine to modify a master print image so that a resulting decoration appears as intended. For example, if the master print image specifies a color density of 40%, then the print characterization file can be used to determine that instructing the print engine to print a 30% dot will actually result in a decorated item having the intended 40% dot. In embodiments of the present invention, the master image file and print characterization information are created for each production site 309, 311, 313 and for each item background color. In particular, the master image file is the same for all sites and background colors and it is the print characterization information that accounts for variations that may occur during a production run. As a result, a decorated item from any production site 309, 311, 313 on any of a variety of background materials or colors will have a uniform appearance when produced because of the inclusion of the print characterization information.

Once the master image file for printing and the print characterization information are finalized, they can be sent to one or more remote production sites 309, 311, 313. A number of file transfer methods, as would be known to one of ordinary skill, are contemplated within the scope of the present invention. One advantageous method includes using file transfer protocol (FTP) to make the files available to the remote sites. For example, the pre-press process system 304 (or possibly another computer altogether) may act as an FTP server 305 to store a number of master image files and corresponding print characterization information in appropriately arranged hierarchical directories. Access and security restrictions may be employed to selectively prevent unwanted or unauthorized access to the system and the image files stored therein.

The remote computer systems 310, 312, 314 communicate with the system 304 to retrieve an image file and print characterization information. For example, an e-mail or other notification message may be sent to the remote systems 310, 312, 314 informing them of the availability, via FTP, of the files at the system 304. Once the notification is received, a user at the remote sites may then connect with the system 304 and download the master image file and characterization information to a remote system 310, 312, 314. According to this advantageous method, a small e-mail message may be used to notify a remote site about the availability of the image file without actually transmitting the entire image file, which may be hundreds of megabytes, if not more, to the remote systems 310, 312, 314. The master image file and the print characterization information may be stored in separated files which are individually downloaded by a remote system 310, 312, 314 and then combined locally to generate a print file. Alternatively, the central pre-process system 304 may combine the master image file and the print characterization information into a print file before making it available to the remote systems 310, 312, 314. In either case, the print file used by a print engine (320) includes print characterization information to ensure that all decorated items in a production run are uniform in appearance.

A variety of alternative methods and communications links may also be used to transfer image files and characterization information to the remote systems 310, 312, 314. For example, the files may be “pushed” to the remote systems 310, 312, 314 immediately upon their creation so that the remote systems 310, 312, 314 do not have to proactively retrieve the files. Also, the connection between the pre-press process system 304 and the remote systems 310, 312, 314 may be via the Internet, a private WAN, or a satellite link, for example.

The description of one remote location 309 is provided below; however, it is understood that similar functionality occurs at each of the remote locations 311, 313 depicted in FIG. 3. Also, FIG. 3 shows three remote locations merely as an example, fewer or more remote locations are contemplated within the scope of the present invention. Additionally, different image files and print characterization files may be transferred to different remote locations such that a pre-press process system 304 may support multiple, different remote production locations.

At the remote system 310, the image file and characterization information is retrieved and stored within local memory. The system 310, in addition to storing these files and receiving notifications from the pre-press system 304, controls the operation of the printing engine 320. The system 310 and the printing engine 320 operate together to decorate an object 330 according to an image file and print characterization information that is stored within the system 310. In an advantageous environment, the system 310 includes scheduling software, as known in the art, which allows an operator to specify an image file and the number of times it is to be printed.

With this information, the printing engine 320 is controlled to produce a production run of a number of decorated items 330. Additionally, the system 310 can configure more than one production run (and image file) at a time. Thus, when one production run is complete, a second production run can begin automatically as specified by the system 310. Production personnel will be needed to ensure the items to be decorated are properly positioned and available at their scheduled times.

The item 330 to be decorated may be a variety of different shapes and sizes. Accordingly, safety checks in the software and hardware may be implemented that use optical detection and recognition means to ensure that the correct item 330 for the current image file is presently being used within the production run. In case of an error, the production line can be stopped until the problem is corrected. The items 330 may be planar-shaped, such as a substrate that can remain planar throughout production or later be shaped into a container such as a toothpaste tube. Additionally, the item 330 may be a more three-dimensional container such that it includes a compartment therein.

As described in more detail earlier, the printing engine 320 directly decorates the item 330 as it passes through the printing engine 320. This method of decorating the item 330 avoids the use of labels and other difficulties encountered in conventional container-labeling systems. In addition to the single printing engine 320 shown in the figure, embodiments of the present invention contemplate the use of two or more printing engines operating serially to one another such that each printing engine decorates an item with a different image file.

Additionally, the present exemplary computer system of FIG. 3 provides an opportunity to produce customized items for customers. For example, a single production item (or a very small run) may be easily produced from an image file such as to provide customizable decorations for items (e.g., coffee cups, etc.). In such an exemplary embodiment, a web site or a kiosk at a shopping mall may be used to solicit graphic files from the general public who want customizable decorations for a wide variety of items that they pick from a catalog of items. These graphic files, which may be from a digital camera, a scanner, other imaging software, etc. would be received at the pre-press process system 304 and then prepared for printing. Similar to the method described, a master image file and one or more print characterization files would eventually be received at a remote system 310 and used to control the decoration of the item according to the image file and an appropriate print characterization file.

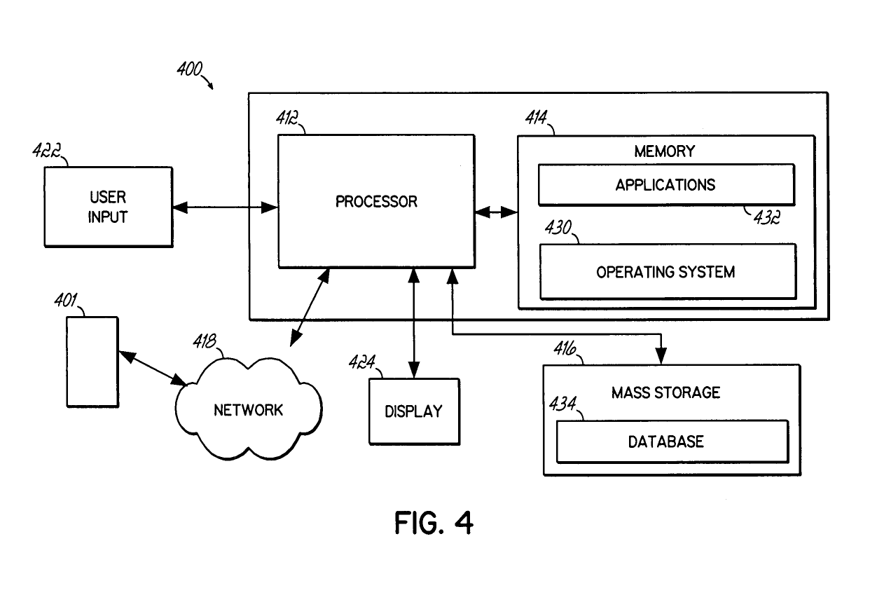

FIG. 4 illustrates an exemplary hardware and software environment for a computer 400 suitable for implementing an environment for controlling a printing engine or for designing and processing printing files consistent with the invention. For the purposes of the invention, the computer 400 may represent practically any type of computer, computer system or other programmable electronic device, including a client computer, a server computer, a portable computer, a handheld computer, an embedded controller, etc. Moreover, the computer 400 may be implemented using one or more networked computers, e.g., in a cluster or other distributed computing system.

Computer 400 typically includes at least one processor 412 coupled to a memory 414. Processor 412 may represent one or more processors (e.g., microprocessors), and memory 414 may represent the random access memory (RAM) devices comprising the main storage of computer 400, as well as any supplemental levels of memory, e.g., cache memories, non-volatile or backup memories (e.g., programmable or flash memories), read-only memories, etc. In addition, memory 414 may be considered to include memory storage physically located elsewhere in computer 400, e.g., any cache memory in a processor 412, as well as any storage capacity used as a virtual memory, e.g., as stored on a mass storage device 416 or on another computer or device coupled to computer 400 via the Internet 418 or some other network (not shown).

Computer 400 also typically receives a number of inputs and outputs for communicating information externally. For interface with a user or operator, computer 400 typically includes one or more user input devices 422 (e.g., a keyboard, a mouse, a trackball, a joystick, a touchpad, and/or a microphone, among others) and a display 424 (e.g., a CRT monitor, an LCD display panel, and/or a speaker, among others). Otherwise, user input may be received via a workstation 401 used by a resident to access the computer 400 via the network 418, or via a dedicated workstation interface or the like.

For additional storage, computer 400 may also include one or more mass storage devices 416, e.g., a floppy or other removable disk drive, a hard disk drive, a direct access storage device (DASD), an optical drive (e.g., a CD drive, a DVD drive, etc.), and/or a tape drive, among others. Furthermore, computer 400 may include an interface with one or more networks 418 (e.g., a LAN, a WAN, a wireless network, and/or the Internet, among others) to permit the communication of information with other computers and devices coupled to the network. It should be appreciated that computer 400 typically includes suitable analog and/or digital interfaces between processor 412 and each of components 414, 416, 418, 422 and 424 as is well known in the art.

Computer 400 operates under the control of an operating system 430, and executes or otherwise relies upon various computer software applications 432, components, programs, objects, modules, data structures, etc. (e.g., database 434, among others). Moreover, various applications, components, programs, objects, modules, etc. may also execute on one or more processors in another computer coupled to computer 400 via another network, e.g., in a distributed or client-server computing environment, whereby the processing required to implement the functions of a computer program may be allocated to multiple computers over the network.

Other hardware components may be incorporated into system 400, as may other software applications. In general, the routines executed to implement the embodiments of the invention, whether implemented as part of an operating system or a specific application, component, program, object, module or sequence of instructions, or even a subset thereof, will be referred to herein as “computer program code” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, magnetic tape, optical disks (e.g., CD-ROM's, DVD's, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein. Those skilled in the art will recognize that the exemplary environment illustrated in FIG. 4 is not intended to limit the present invention. Indeed, those skilled in the art will recognize that other alternative hardware and/or software environments may be used without departing from the scope of the invention.

While the invention has been disclosed by reference to the details of preferred embodiments of the invention, it is to be understood that the disclosure is intended in an illustrative rather than in a limiting sense, as it is contemplated that modifications will readily occur to those skilled in the art, within the spirit of the invention and the scope of the appended claims.

What is claimed is:

1. A decorating apparatus comprising:
a printing engine including a plurality of print heads, each of said print heads operatively connected to an ink supply including a quantity of ink, said plurality of print heads adapted to create images by delivering a plurality of inks onto an item having an interior compartment from said plurality of print heads;
wherein said images are created on a surface of said item during a single pass of said printing engine proximal to said item to deliver ink thereto.

2. The apparatus of claim 1, wherein said plurality of print heads and said item are positioned relative to one another to decorate said item in the absence of any physical contact between said item and said plurality of print heads.

3. The apparatus of claim 1, wherein said printing engine is a component of an ink-jet printer.

4. The apparatus of claim 1, wherein said plurality of inks are delivered from said plurality of print heads by a method chosen from ejecting, spraying, dropping, or jetting.

5. The apparatus of claim 4, wherein said plurality of inks are delivered to said item via a drop-on-demand delivery method.

6. The apparatus of claim 5, wherein said drop-on-demand delivery method of said plurality of inks are induced via a piezo-electric crystal.

7. The apparatus of claim 1, wherein said plurality of inks includes a UV ink.

8. The apparatus of claim 1, wherein said item includes at least one surface to be decorated and said plurality of inks is delivered directly onto said surface.

9. The apparatus of claim 1, wherein said item includes at least one surface to be decorated and said plurality of inks are delivered indirectly onto said surface.

10. The apparatus of claim 1, wherein said images include interpretable information.

11. The apparatus of claim 1, wherein said images are digital images.

12. The apparatus of claim 11, wherein said images are created at a first location, said first location being remote from said plurality of print heads.

13. The apparatus of claim 12, wherein said images are transferred from said first location to a component operatively connected to said plurality of print heads.

14. The apparatus of claim 1, wherein said item is one of a plurality of items, said plurality of items including a first item and a second item, and said images include a first image and a second image.

15. The apparatus of claim 14, wherein said first image is created on said first item and said second image is created on said second item.

16. A method of decorating an item comprising:
operatively connecting an ink source including at least one ink, to a printing engine including a plurality of print heads;
positioning an item to be decorated including at least one surface to be decorated and said ink source relative to one another such that ink may be delivered onto said at least one surface of said item, said item including an interior compartment; and
delivering ink onto said at least one surface of said item during a single pass of said printing engine proximal to said item in order to create images on said at least one surface.

17. The method of claim 16, further comprising delivering ink onto said at least one surface of said item in the absence of any physical contact between said item and said print heads.

18. The method of claim 16, wherein said printing engine is a component of an ink-jet printer.

19. The method of claim 16, wherein each one of said plurality of print heads delivers ink of a color that differs from the color of ink delivered by each of the other of the plurality of print heads.

20. The method of claim 19, wherein delivering ink from said printing engine further includes at least one of ejecting, spraying, dropping, or jetting said ink from said printing engine onto said item.

21. The method of claim 16, wherein said plurality of inks are a UV ink.

22. The method of claim 20, wherein delivering ink from said printing engine to said item further comprises dropping ink on demand onto said at least one surface of said item.

23. The method of claim 22, further comprising altering the shape of a piezo-electric crystal in order to drop said ink on demand onto said at least one surface of said item.

24. The method of claim 16, wherein delivering ink onto said at least one surface of said item occurs directly.

25. The method of claim 16, wherein delivering ink onto said at least one surface of said item occurs indirectly.

26. The method of claim 16, wherein said images include interpretable information.

27. The method of claim 16, wherein said images are digital images.

28. The method of claim 27, further comprising creating said images at a first location remote from said plurality of print heads.

29. The method of claim 28, further comprising transferring said images from said first location to a single decorating apparatus.

30. The method of claim 28, further comprising transferring said images from said first location to a plurality of decorating apparatus.

31. The method of claim 30, wherein said transferring occurs simultaneously to each of said plurality of decorating apparatus.

32. The method of claim 30, wherein said plurality of decorating apparatus includes a first and second decorating apparatus, said first apparatus being geographically distant from said second apparatus.

33. The method of claim 30, wherein the images transferred to a surface of an item at each of said plurality of decorating apparatus is identical to one another.

34. The method of claim 16, wherein said item is one of a plurality of items, said plurality of items including a first item and a second item, and said images include a first image and a second image.

35. The method of claim 34, wherein said first image is created on said first item and said second image is created on said second item.

36. The method of claim 35, wherein said first item and said second item are decorated at a first location.

37. The method of claim 35, wherein said first item is decorated at a first location and said second item is decorated at a second location.

38. A method of presenting an item to be decorated to a decorating apparatus, the method comprising:
positioning an item to be decorated in proximity to a plurality of print heads, such that said plurality of print heads confronts said item but does not physically contact said item, each of said print heads operatively connected to an ink supply including a quantity of ink, said item having an interior compartment; and
creating images on said item wherein said images are created on a surface of said item during a single pass of said print heads proximal to said item to deliver ink thereto.

39. The method of claim 38, wherein said plurality of print heads and/or said item are positioned relative to one another to decorate said item in the absence of any physical contact between said item and said plurality of print heads.

40. The method of claim 38, wherein creating images on said item further comprises moving said plurality of print heads and said item relative to one another while delivering ink to said item, said moving being accomplished during delivery of said ink operable to create said images.

41. The method of claim 40, wherein said item remains stationary and said plurality of print heads move relative to said item.

42. The method of claim 40, wherein said plurality of print heads remain stationary and said item moves relative to said plurality of print heads.

43. The method of claim 38, wherein said item includes a surface to be labeled and creating images on said item further comprises delivering ink to said surface.

44. The method of claim 43, wherein said surface includes a contour.

45. The method of claim 44, wherein said item remains stationary and said plurality of print heads move relative to said item and in conjunction with said contour such that as said plurality of print heads move said plurality of print heads remains a substantially constant distance from said surface.

46. The method of claim 44, wherein said plurality of print heads remain stationary and said item moves relative to said plurality of print heads and in conjunction with said contour such that as said item moves said item remains a substantially constant distance from said plurality of print heads.

47. A decoration for an item comprising:
at least one ink layer delivered onto a surface of an item having an interior compartment in a configuration to create images on said surface;
wherein said ink layer is applied to said item via a single pass of a printing engine proximal to said item to deliver said ink layer thereto.

48. The decoration of claim 47, wherein said ink layer is applied in the absence of any physical contact between said item and said printing engine.

49. The decoration of claim 47, wherein said images include interpretable information.

50. The decoration of claim 47, wherein said images include random graphics.

51. A method for decorating an item with an image, the method comprising the steps of:
receiving at a first computer a notification related to availability of an image file;
retrieving from a memory the image file and print characterization information; and
controlling a printing engine, coupled with the first computer, based on the image file and the print characterization information so as to print the image on the item.

52. The method according to claim 51, wherein the notification comprises an electronic mail message.

53. The method according to claim 51, wherein the memory is located remotely from the first computer.

54. The method according to claim 51, wherein the step of retrieving includes the step of downloading the image file and print characterization information from a second computer to the first computer.

55. The method according to claim 54, wherein the notification is received from the second computer.

56. The method according to claim 54, wherein the downloading is performed using file transfer protocol (FTP).

57. The method according to claim 51, wherein the item is generally planar.

58. The method according to claim 51, wherein the item includes an interior compartment.

59. The method according to claim 51, wherein the printing engine is a single-pass inkjet engine.

60. The method according to claim 51, wherein the memory is located locally to the first computer and the image file and print characterization information is sent to the memory from a second computer.

61. The method according to claim 51, wherein the image file and the print characterization information is included in a single file.

62. The method according to claim 51, wherein the print characterization information is included in a file separate from the image file.

63. The method according to claim 51, wherein the print characterization information includes one or more print curves related to the printing engine.

64. The method according to claim 51, wherein the print characterization information includes one or more print curves related to a background color of the item.

65. A system for decorating an item with an image, the system comprising:
a first computer configured to receive notification, from a second computer, of availability of an image file;
the first computer further configured to retrieve the image file and corresponding print characterization information from a memory; and
a printing engine coupled with the first computer and controlled by the first computer so as to print the image on the item according to the image file and the print characterization information.

66. The system according to claim 65, wherein the image file consists essentially of a single copy of the image.

67. The system according to claim 65, wherein the printing engine is a single-pass inkjet printing engine.

68. The system according to claim 65, wherein the memory is located remotely from the first computer.

69. The system according to claim 65, wherein the notification is an electronic mail message.

70. The system according to claim 65, wherein the inkjet printing engine is configured to decorate a plurality of items with the image.

71. The system according to claim 65, wherein the item is generally planar.

72. The system according to claim 65, wherein the item includes an interior compartment.

73. The system according to claim 65, wherein the print characterization information includes one or more print curves related to the printing engine.

74. The system according to claim 65, wherein the print characterization information includes one or more print curves related to a background color of the item.

75. A method for distributing an image with which to decorate an item, the method comprising:
generating a master image file and print characterization information at a first computer;
sending a notification of the availability of the master image file to a remotely located second computer; and
forwarding the master image file and print characterization information to a memory that is remotely located from, and accessible by, the second computer.

76. The method of claim 75, further comprising the step of:
transferring the master image file and print characterization information from the memory to the second computer.

77. The method of claim 76, wherein the step of transferring is performed by the first computer in response to a request for the printable image file being received from the second computer.

78. The method of claim 75 further comprising the step of:
controlling a printing engine coupled with the second computer to decorate a local item according to the master image file and the print characterization file.

79. The method of claim 78, wherein the printing engine is a single-pass inkjet printing engine.

80. The method of claim 75, wherein the master image file consists essentially of a single copy of the image.

81. The method of claim 75, wherein the print characterization information includes one or more print curves related to the printing engine.

82. The method of claim 75, wherein the print characterization information includes one or more print curves related to a background color of the item.

83. A system for producing an item decorated with an image, the system comprising:
a first computer coupled with an first printing engine;
a second computer located remotely from the first computer and coupled with a second printing engine, substantially the same as the first printing engine;
the first computer configured to notify the second computer of the availability of an image file and to forward the image file and corresponding print characterization information to a memory accessible by the second computer; and
the second computer configured to retrieve the image file and corresponding print characterization information from the memory.

84. The system of claim 83, wherein the first computer is configured to generate the image file.

85. The system of claim 83, wherein the first computer is configured to receive an initial graphic file and transform the initial graphic file into the image file.

86. The system of claim 83, wherein the second computer is configured to control the second printing engine to decorate the item according to the image file and the print characterization information.

87. The system of claim 83, wherein the second computer is configured to control the second printing engine to decorate a plurality of items with the image file and the print characterization information.

88. The system of claim 83, wherein the first and second printing engines each comprise a single-pass inkjet printing engine.

89. A method for producing an item decorated with an image, comprising the steps of:
generating an image file and corresponding print characterization information at a first computer;
sending a notification about the availability of the image file from the first computer to a second computer located remotely from the first computer;
forwarding the image file and print characterization information to a memory accessible by the second computer; and
downloading the image file and the print characterization information from the memory to the second computer.

90. The method according to claim 89, further comprising the step of:
controlling a printing engine coupled to the second computer so as to decorate the item according to the image file and print characterization information.

91. The method of claim 89, wherein the step of generating includes the steps of:
receiving an initial graphic file; and
transforming the initial graphic file into the image file.

92. The method according to claim 89, further comprising the step of:
controlling a local printing engine coupled with the first computer so as to decorate a local item according to the image file and print characterization information.

93. A method of producing decorated items comprising the steps of:
decorating a first item with an image file using a first printing engine coupled to a first computer;
receiving approval from a producer regarding the first item as decorated;
sending the image file to a remotely located second computer coupled with a second printing engine substantially similar to the first printing engine; and
producing a plurality of decorated items at the second printing engine according to the image file.

94. The method of claim 93, wherein the first and second printing engines each comprise a single-pass inkjet printing engine.

95. An apparatus comprising:
at least one processor;
a memory coupled with the at least one processor; and
a program code residing in memory and executed by the at least one processor, the program code configured to:
receive notification related to availability of an image file;
retrieve from a memory the image file and corresponding print characterization information; and
control a printing engine, coupled thereto, based on the image file and print characterization information so as to print the image on the item.

96. An apparatus comprising:
at least one processor;
a first memory coupled with the at least one processor; and
a program code residing in memory and executed by the at least one processor, the program code configured to:
generate a printable image file and print characterization information;
send a notification of the availability of the printable image file to a remotely located processor; and
forward the printable image file and print characterization information to a second memory that is accessible by the second processor.

97. A program product, comprising:
a program code configured upon execution to:
receive at a first computer notification related to availability of an image file;
retrieve from a memory the image file and corresponding print characterization information; and
control a printing engine, coupled with the first computer, based on the image file and print characterization information so as to print the image on the item; and
a signal bearing computer-readable medium bearing the program code.

98. A program product, comprising:
a program code configured upon execution to:
generate a printable image file and corresponding print characterization information at a first computer;
send a notification of the availability of the printable image file to a remotely located second computer; and
forward the printable image file and print characterization information to a memory that is accessible by the second computer; and
a signal bearing computer-readable medium bearing the program code.
